(19) United States
(12) Patent Application Publication
(10) Pub. No.: US 2008/0077297 A1
(43) Pub. Date: Mar. 27, 2008

(54) CONTROL APPARATUS AND METHOD FOR VEHICLE, PROGRAM FOR IMPLEMENTING THE CONTROL METHOD WITH COMPUTER AND STORAGE MEDIUM FOR STORING THE PROGRAM

(75) Inventors: Masatoshi ITO, Okazaki-shi (JP); Tsuyoshi Mikami, Nisshin-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/855,445

(22) Filed: Sep. 14, 2007

(30) Foreign Application Priority Data
Sep. 25, 2006 (JP) 2006-258845

(51) Int. Cl. G06F 17/00

(52) U.S. Cl. 701/48; 477/98

(57) ABSTRACT

A control apparatus for a vehicle having an engine and an automatic transmission includes a rotational speed detection unit that detects the engine speed; a temperature detection unit that detects the temperature of automatic transmission fluid; an calculation unit that calculates a degree of agitation of the automatic transmission fluid based on the detected engine speed and the automatic transmission fluid temperature; an adding unit for adding the calculated degree of agitation to a previously calculated degree of agitation; and a control unit for controlling the automatic transmission based on the sum degree to prevent increasing the degree of agitation.

### INCORPORATION BY REFERENCE

The disclosure of Japanese Patent Application No. 2006-258845 fled on Sep. 25, 2006 including the specification, drawings and abstract is incorporated herein by reference in its entirety.

### BACKGROUND OF THE INVENTION

1. Field of the Invention

The present invention relates to a control apparatus and method of an automatic transmission installed in a vehicle; and more particularly, to a control apparatus and method of an automatic transmission based on a state of automatic transmission fluid in the automatic transmission.

2. Description of the Related Art

It is very common that automatic transmissions (AT) are used in vehicles, especially in passenger cars. The AT is configured with a torque converter and a gear shifting mechanism (of a stepped type using gears or the like, or of a continuously variable type using belts or the like). The torque converter and the gear mechanism are filled with automatic transmission fluid (oil). When the temperature of the automatic transmission fluid in the automatic transmission increases, the automatic transmission fluid expands, and the level thereof thus increases. At this time, if rotating elements of the gear-based gear shifting mechanism, such as a clutch drum, internal gears and the like, agitate the automatic transmission fluid, the mechanical loss is increased and its temperature rises further. As a result, the durability of the automatic transmission is degraded.

For example, Japanese Patent Publication Application No. JP-A-8-193655 describes a gear shifting control device for an automatic transmission having a manual shifting mode, that prevents the temperature of the automatic transmission fluid from increasing due to selection of an inappropriate gear speed. The gear shifting control device is coupled to an internal combustion engine, and allows an operator to select either an automatic gear shifting mode in which the gears are shifted automatically based on a specific shift pattern, or a manual shifting mode in which gear shifting is performed in response to a manipulation of a shift lever by the driver. Further, the above gear shifting control device is equipped with an automatic transmission fluid (ATF) temperature sensor for detecting the temperature of the ATF in the automatic transmission. Thus, when the ATF temperature detected by the automatic transmission fluid temperature sensor is higher than or equal to a first preset value, the gear shifting is performed automatically even during the manual shifting mode.

In accordance with the described gear shifting control device, the temperature increase in the ATF due to selection of an inappropriate gear speed is rapidly compensated for to thereby prevent any decrease in the lifespan of the automatic transmission fluid, resin parts and seal members.

However, if the ATF is at a high temperature, the level of the ATF is raised by bubbles formed therein and the expansion of the automatic transmission fluid resulting from the high temperature thereof This results in a problem in that, when the automatic transmission fluid is agitated by the rotating elements, it leaks through a breather plug. This is because the leakage of the automatic transmission fluid through the breather plug due to the agitation of the automatic transmission fluid is greatly affected by the rotation of the rotating elements as well as the temperature of the automatic transmission fluid.

Meanwhile, in the gear shifting control device described in the above document, the automatic transmission is controlled based on the temperature of the ATF. For this reason, the agitation state of the automatic transmission fluid cannot be precisely determined. Therefore, the above-described problem of the gear shifting control device cannot be solved by using the gear shifting control device disclosed in the above document.

### SUMMARY OF THE INVENTION

The invention provides a control apparatus and method for a vehicle that determines the state of automatic transmission fluid in an automatic transmission to thereby prevent the automatic transmission fluid from leaking through a breather plug; a program for implementing the control method by using a computer; and a storage medium on which the program is stored.

In accordance with a first aspect of the invention, there is provided a control apparatus for a vehicle having an engine and an automatic transmission installed therein. The control apparatus includes a rotational speed sensor that detects the rotational speed of the engine; temperature sensor that detects the temperature of automatic transmission fluid (ATF) in the automatic transmission; a calculation unit that calculates the degree of agitation of the automatic transmission fluid based on the rotational speed and the temperature; an adding unit that adds the calculated degree of agitation to a previously calculated degree of agitation; and a control unit that controls the automatic transmission based on the calculated degree of agitation to prevent increasing the degree of agitation.

A control method of a vehicle in accordance with a second aspect of the invention has the same configuration as the control apparatus of a vehicle in accordance with the first aspect of the invention.

In accordance with the first aspect of the invention, the degree of agitation of the automatic transmission fluid is calculated based on the rotational speed and the automatic transmission fluid temperature. The calculated degree is added to a previously calculated degree. By increasing, for example, the calculated degree as the rotational speed and the automatic transmission fluid temperature increases, and to decrease (e.g. a negative value) as either the rotational speed or the temperature of the automatic transmission fluid decreases, if the sum degree is high, it can be determined that the rotational speed and the automatic transmission fluid temperature are maintained at a high level. In other words, it can be determined that the ATF of the automatic transmission is at a high temperature and in a state where the degree of agitation is high due to the rotating elements of the automatic transmission (e.g., gears). Therefore, by controlling the automatic transmission such that the degree of agitation is not increased (e.g. by prohibiting downshifting in the deceleration direction and by shifting to the highest gear) based on the sum degree (e.g. when the sum degree is higher than the preset value), an increase in the degree of agitation of the automatic transmission fluid may be suppressed before the automatic transmission fluid starts to leak through the breather plug. Thus, deterioration in the driving efficiency due to a further increase in the temperature and the agitation of the automatic transmission fluid may be avoided. Therefore, it is possible to provide a vehicle control apparatus that prevents automatic transmission fluid from leaking through a breather plug by accurately determining a state of automatic transmission fluid in an automatic transmission.

The calculation unit may obtains a higher degree as the rotational speed and temperature increase, and a lower degree as either the rotational speed or the temperature decreases.

With this configuration, the higher the rotational speed and the automatic transmission fluid temperature become, the higher the calculated degree becomes; the lower either the rotational speed or the automatic transmission fluid temperature becomes, the lower the calculated degree becomes (e.g. a negative value). For this reason, if the sum degree is high, it can be determined that a high rotational speed and automatic transmission fluid temperature are maintained. In other words, it can be determined that the automatic transmission fluid in the automatic transmission is at a high temperature, and that the degree of agitation caused by the rotating elements (e.g. gears) in the automatic transmission is at a high level.

The control unit may further include a regulator that controls the automatic transmission to prevent an increase in the rotational speed of the engine if the sum degree is higher than a preset degree.

With this configuration, when the sum degree is higher than the preset value, the automatic transmission is controlled such that the engine rotational speed is not increased due to the gear shifting (e.g. by prohibiting downshifting in the deceleration direction and by shifting to the highest gear). Thereby, the increase in the degree of agitation of the automatic transmission fluid can be prevented before the automatic transmission fluid starts to leak through the breather plug.

The control unit may include a prohibition unit that prohibits downshifting.

With this configuration, gear shifting that increases the engine rotational speed is prevented by prohibiting downshifting. In other words, an increase in the engine rotational speed is suppressed. For this reason, an increase in the degree of agitation of the automatic transmission fluid can be suppressed before the automatic transmission fluid starts to leak through the breather plug.

The prohibition unit may also include a prevention unit that prohibits the downshifting if the sum degree is higher than the preset degree, and further if a preset condition for at least one of an opening degree of an accelerator, a depression force of a brake pedal and a rotational speed of an output shaft in the automatic transmission is met.

With this configuration, downshifting is prohibited if the preset condition for at least one of the accelerator operating amount, the depression force of the brake pedal and the output shaft rotational speed of the automatic transmission is met in addition to the condition that the sum degree is higher than the preset degree. By, for example, setting the preset such that the vehicle can be protected from a shock despite the prohibition of downshifting, the automatic transmission can be controlled to suppress an increase in the degree of agitation at a proper timing. Thus, passengers in the vehicle may be protected from uncomfortable feelings caused by a shock in the vehicle.

The control unit may include a prohibition cancellation unit for canceling the prohibition of the downshifting if the sum degree is lower than a preset degree.

With this configuration, when the sum degree becomes lower than the preset degree, the prohibition of downshifting is canceled. Thereby, when either the rotational speed or the automatic transmission fluid temperature is lowered, the prohibition of downshifting may be canceled. When either the rotational speed or the automatic transmission fluid temperature is lowered, the degree of agitation is decreased. In response to the decrease in the degree of agitation, the prohibition of downshifting can be canceled rapidly. Thus, the gear shifting control of the automatic transmission according to the intention of the driver can be resumed shortly.

The prohibition cancellation unit may include a prohibition canceling unit that cancels the prohibition of the downshifting if the sum degree is less than a preset degree, and further if a preset condition for at least one of an opening degree of an accelerator, a depression force of a brake pedal and a rotational speed of an output shaft in the automatic transmission is met.

With this configuration, if the preset condition for at least one of the accelerator operation amount, the depression force of the brake pedal and the output shaft rotational speed of the automatic transmission is met in addition to the condition that the sum degree is less than the preset degree, the prohibition of downshifting is canceled. For example, by setting the preset condition such that the vehicle can be protected from a shock despite the prohibition of downshifting, the automatic transmission may be controlled to suppress an increase in the degree of agitation at a proper timing. Thus, passengers in the vehicle are protected from uncomfortable feelings caused by a shock in the vehicle.

The automatic transmission may also include a mode in which the rotational speed of the engine at a speed of the vehicle is higher than a normal rotational speed of the engine at the same speed of the vehicle, and the control unit includes a conversion prohibition unit for prohibiting a conversion to the mode.

With this configuration, gear shifting that increases the engine rotational speed is suppressed by prohibiting the conversion to the mode in which the engine rotational speed becomes higher than a normal engine rotational speed at the same speed of the vehicle. For this reason, an increase in the degree of agitation of the automatic transmission fluid may be suppressed before the automatic transmission fluid starts to leak through the breather plug.

The automatic transmission may have a cruise mode in which gear shifting is controlled to either maintain the speed of the vehicle or follow a preceding vehicle, and the control unit includes a cruise mode prohibition unit for prohibiting a conversion to the cruise mode.

With this configuration, a conversion to a cruise mode may be prohibited. Thereby, gear shifting to increase the engine rotational speed is suppressed when, for example, the vehicle speed is lower than a preset speed, or a distance from the preceding vehicle increases. Thus, an increase in the degree of agitation of the automatic transmission fluid may be suppressed before the automatic transmission fluid starts to leak through the breather plug.

The control apparatus may further include a notification unit for notifying a driver of the vehicle of an increase in the degree of agitation when the sum degree is higher than a preset degree.

With this configuration, if the sum degree is higher than or equal to the preset degree, the driver is informed of the increase in the degree of agitation by means of a warning lamp, a warning sound, a vibration or the like. Thus, the driver may be informed that the degree of agitation of the automatic transmission fluid in the automatic transmission is high.

The automatic transmission may have an automatic mode and a manual mode, and the control unit includes a transmission controlling unit for controlling the automatic transmission based on the sum degree to prevent at least a gear shift to a lower gear during the manual mode.

With this configuration, although the driver carries out a manipulation corresponding to downshifting during the manual mode, it is possible to prevent, at least, a gear shifting to a lower gear. Thereby, an increase in the degree of agitation of the automatic transmission fluid is suppressed before the automatic transmission fluid starts to leak through the breather plug.

In accordance with a third aspect of the invention, a program is provided for implementing, by a computer, the control method in accordance with the second aspect of the invention. Further, in accordance with a fourth aspect of the invention, a storage medium is provided for storing a program for implementing, by a computer, the control method in accordance with the second aspect of the invention.

In accordance with the third or the fourth aspect of the invention, the control method in accordance with the second aspect of the invention may be implemented by using a computer.

### BRIEF DESCRIPTION OF THE DRAWINGS

The above and other objects and features of the present invention will become apparent from the following description of exemplary embodiments given in conjunction with the accompanying drawings, in which:

FIG. 1 illustrates a configuration of a powertrain of a vehicle having therein a vehicle control apparatus in accordance with a present embodiment;

FIG. 2 illustrates a gate pattern of a shift gate in a sequential shiftmatic mechanism;

FIG. 3 is a functional block diagram illustrating an ECT_ECU that serves as a vehicle control apparatus in accordance with the present embodiment;

FIG. 4 illustrates agitation values as lines, wherein the agitation values are set by a relationship between automatic transmission fluid temperature and engine rotational speed; and

FIG. 5 is a flowchart illustrating a control flow of a program executed by the ECT_ECU that serves as a vehicle control apparatus in accordance with the present embodiment.

### DETAILED DESCRIPTION OF EMBODIMENTS

Hereinafter, an embodiment of the present invention will be described below in detail with reference to the drawings. In the following description, like parts are denoted by like reference signs. Since names and functions are same therebetween, detailed descriptions thereof will not be repeated.

A powertrain of a vehicle including a control apparatus in accordance with the present embodiment will be described. In the present invention, an automatic transmission will be described as one having a torque converter, which is a fluid coupling having a lock-up clutch, and a gear shifting mechanism. Further, in the present embodiment, the automatic transmission may be either a discontinuously variable one or a continuously variable one.

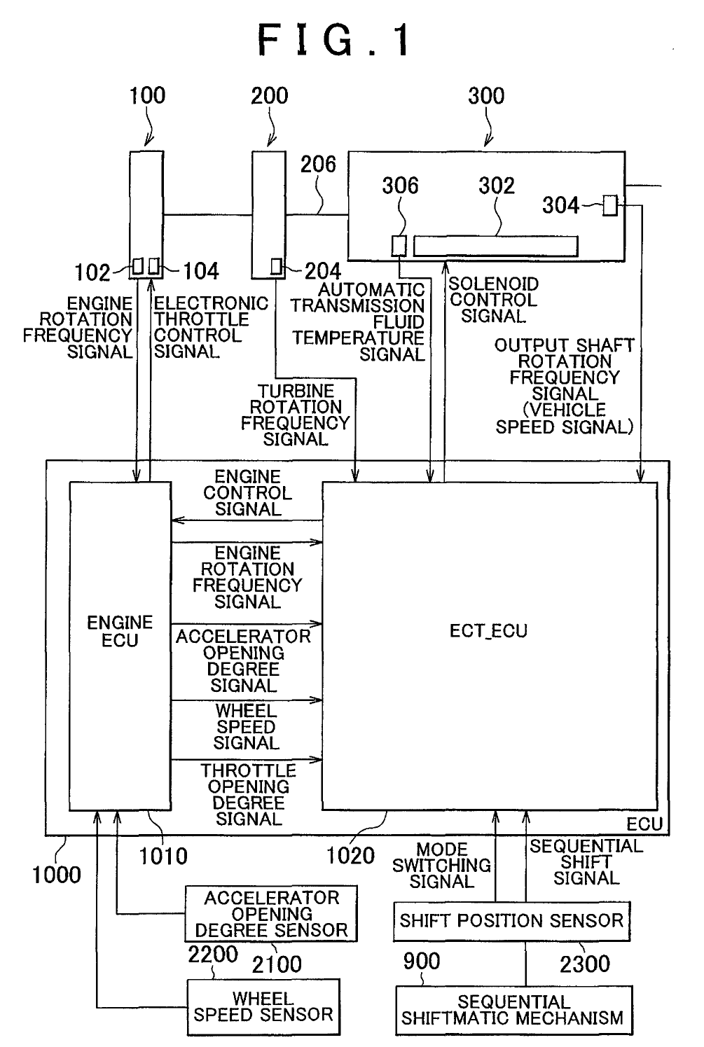

The powertrain of the vehicle including the control apparatus in accordance with the present embodiment will be described with reference to FIG. 1. The control apparatus in accordance with the present embodiment is implemented by using an ECT_ECU 1020 shown in FIG. 1 (“ECT” designates “electronic controlled automatic transmission,” and “ECU” designates “electronic control unit”).

As illustrated in FIG. 1, the powertrain of the vehicle includes an engine 100, a torque converter 200, an automatic transmission 300, and an ECU 1000.

The engine 100 is provided with an electronic throttle 104. The opening degree of the electronic throttle 104 is adjusted by using a throttle motor (not shown), based on an electronic throttle control signal received from an engine ECU 1010.

Further, the engine 100 is provided with an injector (not shown), which injects fuel into the combustion chamber. The injector supplies the fuel into the combustion chamber based on a fuel injection control signal received from the engine ECU 1010.

The output shaft of the engine 100 is connected to an input shaft of the torque converter 200. The engine 100 is coupled to the torque converter 200 by means of a rotating shaft. Therefore, an output shaft rotational speed NE of the engine 100 (or an engine rotational speed NE), which is detected by the engine rotational speed sensor 102, is identical to an input shaft rotational speed of the torque converter 200 (or a pump rotational speed).

The torque converter 200 includes a lock-up clutch (not shown) that allows the input shaft to be directly coupled to the output shaft; a turbine pump impeller (not shown) on the side of the input shaft; another turbine pump impeller (not shown) on the side of the output shaft; and a stator (not shown) provided with a one-way clutch to amplify a torque. The torque converter 200 is connected to the automatic transmission 300 by a rotating shaft 206. A turbine rotational speed sensor 204 detects the output shaft rotational speed NT of the torque converter 200 (i.e., turbine rotational speed NT). Further, an output shaft rotational speed sensor 304 detects the output shaft rotational speed NOUT of the automatic transmission 300.

This automatic transmission 300 is equipped with a plurality of frictional elements such as clutches and brakes. Further, an automatic transmission fluid is injected into the automatic transmission, including the torque converter 200 and the automatic transmission 300. A housing of the automatic transmission is provided, at an upper portion thereof, with a breather plug (not shown), which is installed in an opening through which a fluid chamber, into which the automatic transmission fluid flows, communicates with the outside of the housing to maintain a constant pressure in the automatic transmission.

Based on an operation table set in advance, a hydraulic control circuit 302 is controlled such that frictional elements such as clutch elements (e.g. clutches C1 to C4), brake elements (e.g. brakes B1 to B4) and/or one-way clutch elements (e.g. one-way clutches F0 to F3) are engaged with or disengaged from each other as required from each of the gears. The automatic transmission 300 has gear-shifting positions (or shift positions) that include park (P), reverse (R), neutral (N) and drive (D).

The ECU 1000 that controls the powertrain thereof includes the engine ECU 1010 for controlling the engine 100, and the ECT_ECU 1020 for controlling the automatic transmission 300.

A signal that indicates the output shaft rotational speed NOUT, detected by the output shaft rotational speed sensor 304, is input into the ECT_ECU 1020. Further, an engine rotational speed signal that represents the output shaft rotational speed NE detected by the engine rotational speed sensor 102 is input from the engine ECU 1010 to the ECT_ECU 1020. In addition, a signal that represents the turbine rotational speed NT detected by the turbine rotational speed sensor 204 is input to the ECT_ECU 1020.

The engine rotational speed sensor 102 is installed opposite the teeth of a rotation detecting gear fitted to the output shaft of the engine 100 (the input shaft of the torque converter 200). The output shaft rotational speed sensor 304 is installed opposite the teeth of a rotation detecting gear fitted to the output shaft of the automatic transmission 300. The turbine rotational speed sensor 204 is installed opposite the teeth of a rotation detecting gear fitted to the output shaft of the torque converter 200.

These rotational speed sensors are capable of detecting even a very slight rotation of the input shaft of the torque converter 200, the output shaft of the torque converter 200, and the output shaft of the automatic transmission 300, and are, for example, sensors using magneto-resistive elements that are usually referred to as semiconductor type sensors.

Further, the ECT_ECU 1020 outputs an engine control signal (e.g. a throttle opening degree signal) to the engine ECU 1010, so that the engine ECU 1010 controls the engine 100 based on the engine control signal or other control signal(s). Further, the ECT_ECU 1020 outputs a solenoid control signal to the automatic transmission 300. Based on the solenoid control signal, a linear solenoid control signal, an on-off solenoid valve and the like, that are included in the hydraulic control circuit 302 of the automatic transmission 300, are controlled. Thereby, frictional engagement elements are engaged with or disengaged from each other to form specific gear speeds (e.g. a first to a fifth speed).

Further, a signal that indicates the operating amount of an accelerator pedal operated by a driver is input from an accelerator operating amount sensor 2100 to the ECT_ECU 1020 via the engine ECU 1010. Further, a signal that indicates the rotational speed of wheels (hereinafter, referred to as “wheel rotational speed” or “wheel speed”) is input from a wheel speed sensor 2200 into the ECT_ECU 1020 via the engine ECU 1010. In addition, a signal that indicates the throttle opening degree of the electronic throttle 104 is input from the engine ECU 1010 into the ECT_ECU 1020. The throttle opening degree may be detected either by the throttle opening degree sensor installed in the electronic throttle 104, or by using information obtained from a throttle opening degree control signal. Furthermore, a signal that indicates the temperature of the automatic transmission fluid in the automatic transmission 300 is input from an automatic transmission fluid temperature sensor 306, which is installed in the automatic transmission 300, to the ECT_ECU 1020. Further, a mode switching signal and a sequential shift signal are input from a shift position sensor 2300, which is installed to a sequential shiftmatic mechanism 900 having a shift lever, into the ECT_ECU 1020. Further, the ECT_ECU 1020 has a memory in which various data (threshold values, a gear shifting map and the like) or programs are stored.

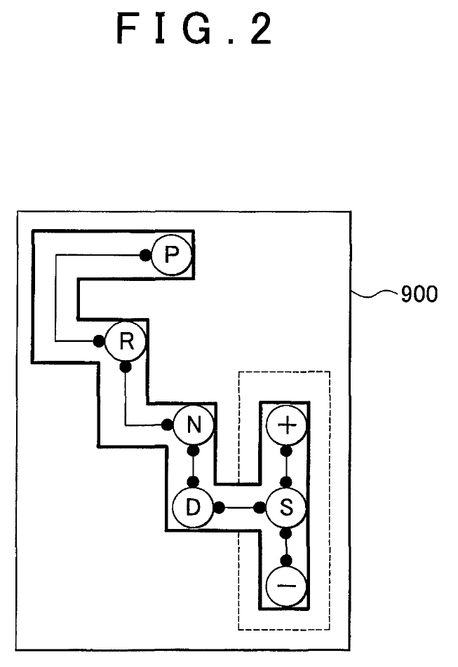

In the vehicle in accordance with the present embodiment, there is installed the sequential shiftmatic mechanism 900 having a sequential shift pattern as illustrated in FIG. 2. Here, the sequential shiftmatic mechanism 900 is a mechanism that allows a manual manipulation by moving the shift lever 902, e.g., from “D” to “S” that is adjacent thereto, and then pushing the shift lever 902 in a forward direction to upshift “+”, or pulling the shift lever 902 in a backward direction to downshift “−”. When the shift lever 902 is in the position “S”, a mode switching signal that represents the conversion from an automatic shifting mode to a manual shifting mode, is input to the ECT_ECU 1020. Further, in response to the operation of the shift lever 902 in a forward direction, a sequential shift signal (or an upshift signal) is input to the ECT_FCU 1020. In response to the operation of the shift lever 902 in a backward direction, another sequential shift signal (or a downshift signal) is input to the ECT_ECU 1020.

When receiving the upshift signal, the ECT_ECU 1020 sets a gear, that is one step higher than the gear currently selected as the highest gear, to be the highest gear. Then, the ECT_ECU 1020 selects an optimal gear based on vehicle conditions (e.g. the accelerator operating amount the throttle opening degree, the engine rotational speed, the turbine rotational speed, the output shaft rotational speed, and the wheel speed) and a gear-shifting diagram of the vehicle. If the newly selected gear is different from the currently selected gear, the ECT_ECU 1020 executes a gear shifting control.

When receiving the downshift signal, the ECT_ECU 1020 sets a gear, that is one step lower than a gear currently selected as the highest gear, to be the highest gear. Then, the ECT_ECU 1020 selects an optimal gear based on the vehicle conditions and the gear-shifting diagram, and, if the newly selected gear is different from the currently selected gear, executes a gear shifting control.

Further, the ECT_ECU 1020 may also be configured such that, when receiving the upshift signal, the ECT_ECU 1020 upshifts the transmission to the gear that is one step higher than the currently selected gear if preset conditions (e.g. an engine rotational speed and a vehicle speed) are met; and, when receiving the downshift signal, the ECT_ECU 1020 downshifts the to the gear that is one step lower than the currently selected gear if the preset conditions are met.

Further, when the shift lever 902 in “D”, the gear shifting is in the automatic shifting mode. Hence, the automatic transmission 300 is controlled by the ECT_ECU 1020 via a hydraulic controller unit 1100. In other words, based on the vehicle conditions and the gear-shifting diagram, the ECT_ECU 1020 selects the optimal gear from all of the gears provided in the automatic transmission 300. If the currently selected gear is different from the optimal gear, the ECT_ECU 1020 performs the gear shifting control to shift to the optimal gear.

In the vehicle with this configuration, the present invention is characterized in the following feature: the ECT_ECU calculates the degree of agitation of the automatic transmission fluid based on the rotational speed of the engine 100 and the temperature of the automatic transmission fluid in the automatic transmission, and adds the calculated degree of agitation to the previously calculated degree of agitation, and controls the automatic transmission based on the sum degree to thereby prevent any increase in the degree of agitation.

More specifically, the degree of agitation calculated by the ECT_ECU 1020 increases as the engine rotational speed and the automatic transmission fluid temperature increase, and decreases as either the engine rotational speed or the automatic transmission fluid temperature decreases. The ECT_ECU 1020 prohibits downshifting if the sum degree is higher than a preset degree. In contrast, the ECT_ECU 1020 cancels the prohibition of downshifting when the sum degree becomes lower than the preset degree. Further, during the manual shifting mode, the ECT_ECU 1020 controls the gear to be fixed at the highest gear.

Further, in the present embodiment, although the calculation of a value representing the degree of agitation of the automatic transmission fluid, the addition of the calculated value, and the control of the automatic transmission have been described as being carried out by the ECT_ECU 1020, they may be carried out by the single ECU, which combines the engine ECU 1010 and the ECT_ECU 1020.

Further, in a hybrid vehicle to which a motor generator and an engine are mounted as a driving source, the engine ECU and HV_ECU may be used for controlling the hybrid vehicle. In this case, the calculation of the value that represents the degree of agitation of the automatic transmission fluid, the addition of the calculated value, and the control of the hybrid vehicle (e.g. the control of the automatic transmission or motor generator) may be carried out by the HV_ECU.

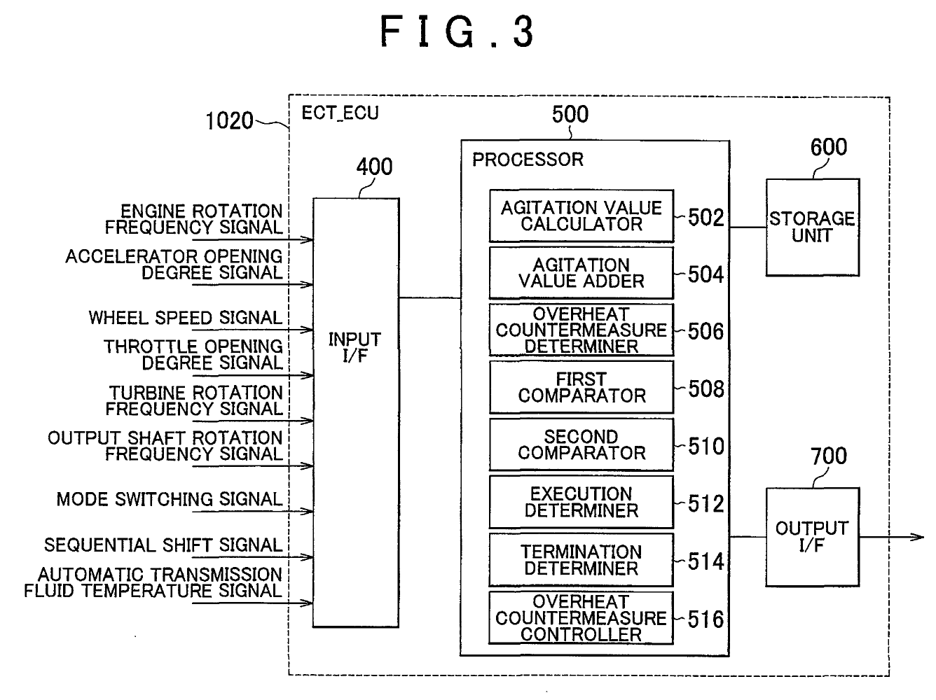

Hereinafter, the configuration of the ECT_ECU 1020, which is the controller unit of the vehicle in accordance with the present embodiment, will be described by using the functional block diagram illustrated in FIG. 3.

As illustrated in FIG. 3, the ECT_ECU 1020 includes an input interface 400 (hereinafter, referred to as “input I/F”) that receives signals from the engine ECU 1010, the turbine rotational speed sensor 204, the output shaft rotational speed sensor 304, the ATF temperature sensor 306, and the shift position sensor 2300; a processor 500 whose main component is a central processing unit (CPU); a storage unit 600 implemented as memory and the like; and an output interface 700 (hereinafter, referred to as “output I/F”) that transmits a solenoid control signal based on the results calculated by the processor 500 to the hydraulic control circuit 302.

In the present embodiment, the input I/F 400 receives an accelerator operating amount signal, an engine rotational speed signal, a turbine rotational speed signal, a wheel speed signal, an output shaft rotational speed signal, a throttle opening degree signal, an ATF temperature signal, a mode switching signal and a sequential shift signal from the engine ECU 1010, the turbine rotational speed sensor 204, the output shaft rotational speed sensor 304, the ATF temperature sensor 306 and the shift position sensor 2300.

The processor 500 includes an agitation value calculator 502, an agitation value adder 504, an overheat countermeasure determiner 506, a first comparator 508, a second comparator 510, an execution determiner 512, a termination determiner 514 and an overheat countermeasure controller 516.

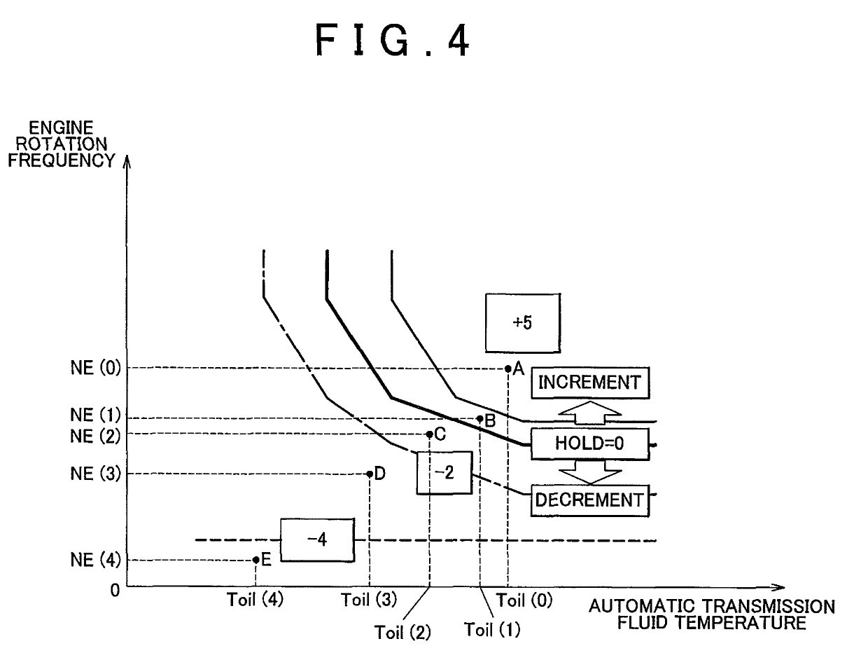

The agitation value calculator 502 calculates a value (hereinafter, referred to as an “agitation value”) that represents the degree of agitation in the ATF based on the rotational speed of the engine 100 and the temperature of the ATF in the automatic transmission. To be more specific, the agitation value calculator 502 calculates the agitation value based on the rotational speed of the engine 100, the temperature of the ATF and a map shown in FIG. 4.

In the map illustrated in FIG. 4, the ATF temperature is denoted on the horizontal axis, and the engine rotational speed is denoted on the vertical axis. As shown therein, the map includes preset lines: line “+5” (thin line), line “HOLD(=0)” (thick line), line “−2” (dashed-dotted line), and line “−4” (dashed line).

Further, the lines in the FIG. 4 are shown as examples and not limited thereto, as long as each line in the map increases as at least the rotational speed and the ATF temperature increase, and to decrease (preferably, below zero) as either the rotational speed or the ATF temperature decreases.

The agitation value calculator 502 calculates the agitation value based on a position specified on the map and a value corresponding to each line in accordance with the detected rotational speed of the engine 100 and the detected ATF temperature.

More specifically, if, for example, the rotational speed of the engine 100 is NE(0) and the ATF temperature is Toil(0), the agitation value calculator 502 specifies point A on the map based on NE(0) and Toil(0). Because point A in the map is located in an area situated above line “+5” in FIG. 4, the agitation value calculator 502 obtains “+5” as the agitation value.

Further, if, for example, the rotational speed of the engine 100 is NE(1) and the ATF temperature is Toil(1), the agitation value calculator 502 specifies point B in the map based on NE(1) and Toil(1). Because point B in the map is located in an area situated between line “+5” and line “HOLD”, the agitation value calculator 502 calculates the agitation value, for instance, by using a linear interpolation based on line “+5” and line “HOLD(=0)”. Here, the interpolation method is not limited to the linear interpolation.

Further, if, for example, the rotational speed of the engine 100 is NE(2) and the ATF temperature is Toil(2), the agitation value calculator 502 specifies point C in the map based on NE(2) and Toil(2). Because point C on the map is located in an area situated between line “HOLD(=0)” and line “−2”, the agitation value calculator 502 calculates the agitation value, for instance, by using a linear interpolation based on line “HOLD(=0)” and line “−2”.

Further, if, for example, the rotational speed of the engine 100 is NE(3) and the ATF temperature is Toil(3), the agitation value calculator 502 specifies point D in the map based on NE(3) and Toil(3). Because point D in the map is in an area is situated between line “−2” and line “−4”, the agitation value calculator 502 calculates the agitation value, for instance, by using a linear interpolation based on line “−2” and line “−4”.

Furthermore, if, for example, the rotational speed of the engine 100 is NE(4) and the ATF temperature is Toil(4), the agitation value calculator 502 specifies point E in the map based on NE(4) and Toil(4). Because point C in the map is in an area situated below line “−4” in FIG. 4, the agitation value calculator 502 obtains “−4” as the agitation value.

Further, the agitation value calculator 502 may calculate the agitation value at every preset cycle of calculation, or whenever a specific period of time elapses.

Further, in addition to the method of calculating the agitation value by using an interpolation in the map illustrated in FIG. 4, there may be applied a method of calculating the agitation value by assigning preset values to a plurality of areas in the map and then obtaining a preset value corresponding to an area as the agitation value.

The agitation value adder 504 adds the agitation value, calculated by the agitation value calculator 502, to a sum of agitation values accumulated up to the preceding cycle of calculation. Further, as an example, if a requirement previously set for the vehicle conditions is satisfied, the agitation value adder 504 may be reset to an initial value. The requirement is, for example, that the ATF temperature is sufficiently low, and that a preset time has elapsed after the engine 100 stopped.

The overheat countermeasure determiner 506 determines whether overheat countermeasure control is being executed. In the present embodiment, the “overheat countermeasure control” refers to the control of prohibiting downshifting in the automatic transmission 300. Further, the “overheat countermeasure control” refers to the control of shifting the gear to the highest gear based on the vehicle conditions and the gear shifting diagram if, during the manual shifting mode, a gear lower than the highest one is selected.

Further, the “overheat countermeasure control” is not limited to the controls described above, as long as at least the automatic transmission 300 is controlled such that the rotational speed of the engine 100 is not increased. For example, if the gear of the automatic transmission is set as a mode (referred to as a “power mod&”) in which the engine rotational speed is higher than a normal engine rotational speed at the same speed of the vehicle, the “overheat countermeasure control” may prohibit conversion to the power mode. Further, if the gear of the automatic transmission is set as a cruise mode in which the gear shifting is control either to maintain a set vehicle speed or to maintain a prescribed distance behind a preceding vehicle, the “overheat countermeasure control” may prohibit conversion to the cruise mode. In addition, the “overheat countermeasure control” may prohibit at least one of downshifting, conversion to the power mode and conversion to the cruise mode.

Further, as an example, the overheat countermeasure determiner 506 may turn on a control determination flag when the overheat countermeasure control is being executed, but turn off the control determination flag when the overheat countermeasure control is not being executed.

The first comparator 508 determines whether an added value is greater than a first predetermined value. The first predetermined value is set based on the degree of agitation of the ATF at which it is probable that the ATF will leak through the breather plug. Here, the first predetermined value may be properly set by experiments or the like. Further, the first comparator 508 may turn on a first counter determination flag, for instance, when the added value is greater than the first preset value.

The second comparator 510 determines whether an added value is greater than a second preset value. The second preset value is set based on the degree of agitation of the ATF that does not result in leaking of the ATF through the breather plug. Here, the second preset value may be properly set by experiments or the like. Further, the second preset value may be equal to or different from the first preset value. In addition, the second comparator 510 may turn on a second counter determination flag, for instance, when the added value is less than the second preset value.

When the overheat countermeasure control is not being executed, and the added value is greater than the first preset value, the execution determiner 512 determines whether an execution condition for the overheat countermeasure control is met. If, for example, the control determination flag is turned off and the counter determination flag is turned on, the execution determiner 512 determines whether the execution condition is met. Here, the execution condition is set in advance with respect to the vehicle conditions. In the present embodiment, the execution condition is set for the accelerator operating amount and the depression force of the brake pedal. More specifically, the execution condition is that the accelerator operating amount is higher than or equal to a preset operating amount, or that the depression force of the brake pedal is greater than a preset depression force. Further, the execution determiner 512 may turn on an execution allowance flag when the execution condition is met.

When the overheat countermeasure control is being executed, and the added value is less than the second preset value, the termination determiner 514 determines whether a termination condition for the overheat countermeasure control is met. If, for example, the control determination flag is turned on, and the second counter determination flag is turned on, the termination determiner 514 determines whether the termination condition for the overheat countermeasure control is met. The termination condition is set in advance with respect to the vehicle conditions. In the present embodiment, the termination condition is set for the output shaft rotational speed. More specifically, the termination condition occurs when the output shaft rotational speed is less than a preset rotational speed at which the vehicle is nearly stopped. Further, the termination determiner 514 may turn off a termination flag when the termination condition is met.

Further, the execution condition and the termination condition may also correspond to a state where the driving force is constant or the brake is being applied; or the execution condition and the termination condition may set for at least one of the accelerator operating amount, the depression force of the brake pedal and the output shaft rotational speed. Thereby, when the overheat countermeasure control is being executed or terminated, the vehicle is protected from a shock.

The overheat countermeasure controller 516 executes or terminates the overheat countermeasure control over the automatic transmission. For example, the overheat countermeasure controller 516 executes the overheat countermeasure control when the execution flag is turned on, and terminates the overheat countermeasure control when the termination flag is turned on.

As described above, the overheat countermeasure prohibits downshifting in the deceleration direction, and to shift the gear to the highest one if, at the manual mode, the current gear is lower than the highest one. That is, the overheat countermeasure controller 516 does not shift the gear to a gear lower than the currently selected gear, even if it is determined, based on the vehicle conditions and the gear shifting diagram, that the gear needs to be shifted to a lower gear than the currently selected gear, or the overheat countermeasure controller 516 receives the sequential shift signal instructing the downshift in response to the driver's manipulation of the shift lever.

Further, if, at the manual mode, it is impossible to shift the gear to the highest one according to the vehicle conditions, the overheat countermeasure controller 516 may shift the transmission to a highest possible gear. In addition, the overheat countermeasure controller 516 may shift the gear based on the vehicle conditions by setting the currently selected gear as the lowest gear.

If the termination condition is met (e.g., when the termination flag is turned on), the overheat countermeasure controller 516 cancels the prohibition of the shifting in the deceleration direction. At this time, the automatic transmission shifts gears based on the vehicle conditions; or downshifts and upshifts in response to the driver's manipulation of the shift lever.

The storage unit 600 stores therein various data of threshold values and programs. Further, the storage unit 600 stores the above-mentioned map shown in FIG. 4.

In the present embodiment, all of the agitation value calculator 502, the agitation value adder 504, the overheat countermeasure determiner 506, the first comparator 508, the second comparator 510, the execution determiner 512, the termination determiner 514 and the overheat countermeasure controller 516 have been described as being embodied as software that is executed by the CPU serving as the processor 500 by executing the programs stored in the storage unit 600. However, they may also be embodied as hardware. Further, the programs described above may be stored in a storage medium to be installed in the vehicle.

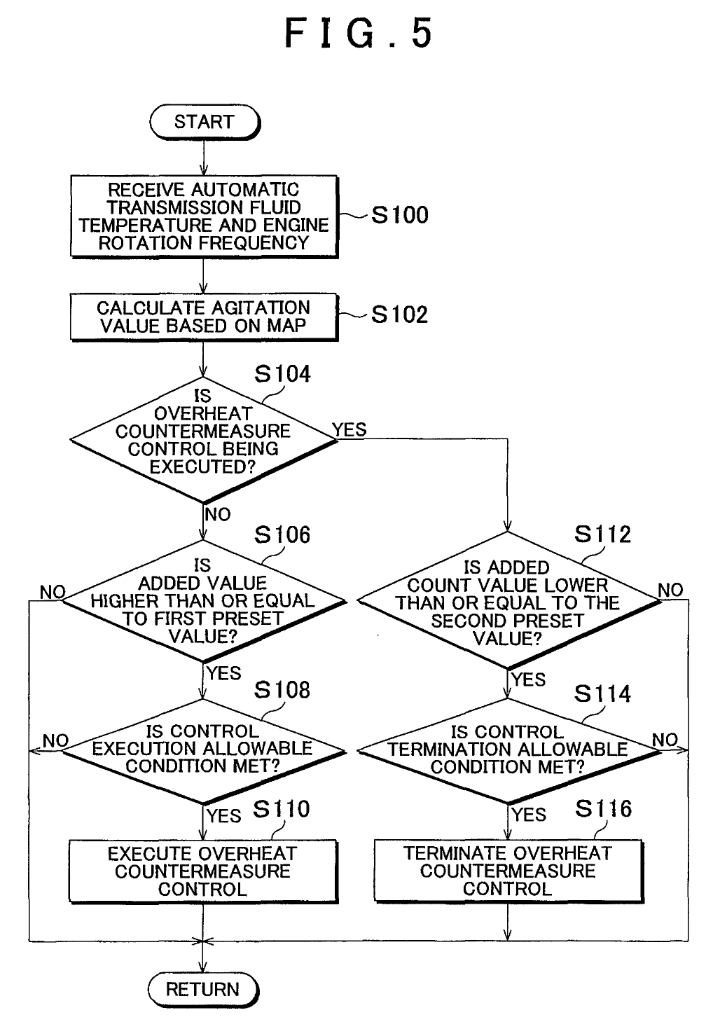

The control flow of the programs executed by the ECT_ECU 1020 in the vehicle control apparatus of the present embodiment having the configuration described above will be described with reference to FIG. 5.

In step S100, the ECT_ECU 1020 receives an engine rotational speed and an automatic transmission fluid temperature from the engine ECU 1010 and the automatic transmission fluid temperature sensor 306, respectively.

In step S102, the ECT_ECU 1020 calculates an agitation value based on the received engine rotational speed, the received automatic transmission fluid temperature and the map illustrated in FIG. 4. Specifically, the ECT_ECU 1020 calculates an agitation value from the map illustrated in FIG. 4 based on the received engine rotational speed and the received automatic transmission fluid temperature, and adds the currently calculated agitation value to a previously calculated agitation value.

In step S104, the ECT_ECU 1020 determines whether an overheat countermeasure control is being executed. If the overheat countermeasure control is being executed (YES in step S104), the process proceeds to step S112. If not (NO in step S104), the process proceeds to step S106.

In step 106, the ECT_ECU 1020 determines whether the added value is greater than or equal to the first preset value. If the added value is greater than or equal to the first preset value (YES in step S106), the process proceeds to step S108. If not NO in step S106), the process is terminated.

In step 108, the ECT_ECU 1020 determines whether a control execution condition is met. If the control execution condition is met (YES in step S108), the process proceeds to step S110. If not (NO in step S108), the process is terminated. In step S110, the ECT_ECU 1020 executes the overheat countermeasure control.

In step S112, the ECT_ECU 1020 determines whether the added value is less than or equal to a second preset value. If the added value is less than or equal to a second preset value (YES in step S112), the process proceeds to step S114. If not (NO in step S112), the process is terminated.

In step S114, the ECT_ECU 1020 determines whether a control termination condition is met. If the control termination condition is met (YES in step S114), the process proceeds to step S116. If not (NO in step S114), the process is terminated. In step S116, the ECT_ECU 1020 terminates the overheat countermeasure control.

The operations of the ECT_ECU 1020, which serves as the vehicle control apparatus in accordance with the present embodiment, will be described based on the configuration thereof and flowchart described above.

As an example, when the engine 100 is started, the agitation value calculated based on the rotational speed, the automatic transmission fluid temperature and the map is added at every cycle of calculation (S100 and S102). If the overheat countermeasure control is not being executed (NO in step S104), it is determined whether the agitation value is greater than or equal to the first preset value (S106). If the agitation value is lower than the first preset value (NO in step S106), the overheat countermeasure control is not executed.

If the automatic transmission fluid temperature of the engine 100 is increased by a driving load of the vehicle or the like, the rotational speed of the engine 100 is increased. Thus, a relatively high value is produced from the calculation as the agitation value. Hence, the added agitation value is increased. When the added value becomes greater than or equal to the first preset value (YES in step S106), and the control execution condition set for the accelerator operating amount and the depression force of the brake pedal is satisfied (YES in step S108), the overheat countermeasure control is executed (S110).

While executing the overheat countermeasure control, downshifting is prohibited. Hence, even if downshifting is instructed as a result of the driver's manipulation of the shift lever, the gear is not shifted to a lower gear. Further, if, at the manual mode, the currently selected gear is lower than the highest one, the gear is shifted to the highest gear.

Furthermore, even if it is determined that the gear needs to be shifted in the deceleration direction based on the vehicle conditions and the gear shifting diagram, the shifting in the deceleration direction is not carried out. Because shifting to the lower gear is not carried out, the engine rotational speed is not increased by such shifting. Further, when the shifting to a higher gear is carried out, the engine rotational speed is reduced. For this reason, the degree of agitation of the automatic transmission fluid is reduced.

While the agitation value is being calculated (S100 and S102), if the overheat countermeasure control is being executed (YES in step S104), it is determined whether the added value is lower than or equal to the second preset value (S112). If the added value is higher than the second preset value (NO in step S112), the overheat countermeasure control is continues to be executed.

If the automatic transmission fluid temperature of the engine 100 or the rotational speed of the engine 100 is lowered due to a reduction in the driving load of the vehicle or shifting to a higher gear, a value below zero is resulted from the calculation as the agitation value. Hence, the added agitation value is reduced. If the added value is less than or equal to the second preset value (YES in step S112), and a termination condition for the output shaft rotational speed is met (YES in step S114), the overheat countermeasure control is terminated (S116).

In other words, if the operation of the shift lever indicates that a downshift is desired, the shift to the lower gear is carried out according to the instruction. Further, if an optimal gear based on the vehicle conditions and the gear-shifting diagram is lower than the currently selected gear, the gear is shifted to a lower gear.

As described above, in accordance with the vehicle control apparatus of the present embodiment, the agitation value that represents the degree of agitation of the automatic transmission fluid is calculated based on the rotational speed and the automatic transmission fluid temperature. Thus calculated value is added to the previously calculated value. The higher the rotational speed and the automatic transmission fluid temperature become, the greater the calculated value becomes. The lower either the rotational speed or the automatic transmission fluid temperature becomes, the lower the calculated value becomes. Therefore, if the added value is high, it can be determined that the rotational speed and the automatic transmission fluid temperature are maintained to be high. In other words, without using a level sensor for detecting a level of automatic transmission fluid, it can be determined that the automatic transmission fluid in the automatic transmission is at a high temperature, and that the degree of agitation caused by the gears and the like of the automatic transmission is high.

As such, if the added value is greater than or equal to the preset value, downshifting in the deceleration direction is prevented, and the automatic transmission is controlled not to increase the engine rotational speed. Thereby, an increase in the degree of agitation of the automatic transmission fluid can be suppressed before the automatic transmission fluid starts to leak through the breather plug. Thus, deterioration of the driving efficiency, due to a further increase in the temperature and the agitation of the automatic transmission fluid, can be avoided. Therefore, it is possible to provide a vehicle control apparatus that prevents the automatic transmission fluid from leaking through the breather plug by accurately determining a state of the automatic transmission fluid in the automatic transmission.

The vehicle may be provided with a notification unit including a warning lamp, a warning horn, and the like. Specifically, if the added value is greater than or equal to the preset value, the ECT_ECU may control the notification unit by turning on the warning lamp, sounding the warning horn, generating vibrations in such parts (e.g. a steering wheel, a seat and/or the like) that are in contact with the driver. Thereby, the driver can be notified that the degree of agitation of the automatic transmission fluid of the automatic transmission is high.

It should be understood that the embodiments are, in all respects, disclosed by way of example and not by way of limitation. The scope of the present invention is set forth by the claims rather than the above description, and should be construed to include all modifications that fall within the scope of the claims.

What is claimed is:

1. A control apparatus for a vehicle having an engine and an automatic transmission installed therein, the control apparatus comprising:
a rotational speed detection unit that detects a rotational speed of the engine;
a temperature detection unit that detects a temperature of an automatic transmission fluid in the automatic transmission;
an calculation unit that calculates a degree of agitation of the automatic transmission fluid based on the rotational speed and the temperature;
an adding unit that adds the calculated degree of agitation to a previously calculated degree of agitation to obtain a sum degree; and
a control unit that controls the automatic transmission based on the sum degree to prevent increasing the degree of agitation.

2. The control apparatus according to claim 1, wherein the calculation unit obtains a higher degree as the rotational speed and the temperature increase, and a lower degree as either the rotational speed or the temperature decreases.

3. The control apparatus according to claim 1, wherein the control unit includes a regulation unit that controls the automatic transmission to prevent an increase in the rotational speed of the engine if the sum degree is higher than a preset degree.

4. The control apparatus according to claim 3, wherein the control unit includes a prohibition unit that prohibits downshifting.

5. The control apparatus according to claim 4, wherein the prohibition unit includes a prevention unit that prohibits downshifting when the sum degree is higher than the preset degree, and a preset condition for at least one of an operating amount of an accelerator, a depression force of a brake pedal and a rotational speed of an output shaft in the automatic transmission is met.

6. The control apparatus according to claim 4, wherein the control unit includes a prohibition cancellation unit that cancels the prohibition of the downshifting when the sum degree is lower than the preset degree.

7. The control apparatus according to claim 6, wherein the prohibition cancellation unit includes a prohibition canceling unit that cancels the prohibition of the downshifting when the sum degree is less than the preset degree, and a preset condition for at least one of an opening degree of an accelerator, a depression force of a brake pedal and a rotational speed of an output shaft in the automatic transmission is met.

8. The control apparatus according to claim 1, wherein the automatic transmission has a rotation elevation mode in which the rotational speed of the engine at a given speed of the vehicle is higher than a normal rotational speed of the engine at the given speed of the vehicle, and
wherein the control unit includes a conversion prohibition unit for prohibiting a conversion to the rotation elevation mode.

9. The control apparatus according to claim 1, wherein the automatic transmission has a cruise mode in which gear shifting is controlled either to maintain a predetermined vehicle speed or maintain a predetermined distance behind a preceding vehicle, and
wherein the control unit includes a cruise mode prohibition unit that prohibits conversion to the cruise mode.

10. The control apparatus according to claim 1, further comprising:
a notification unit that notifies a driver of the vehicle of an increase in the degree of agitation, when the sum degree is higher than a preset degree.

11. The control apparatus according to claim 1, wherein the automatic transmission has an automatic mode and a manual mode, and
wherein the control unit includes a transmission controlling unit that controls the automatic transmission based on the sum degree to prevent at least a downshift during the manual mode.

12. A control method of a vehicle having an engine and an automatic transmission installed therein, the control method comprising:
detecting a speed of the engine;
detecting a temperature of an automatic transmission fluid in the automatic transmission;
calculating a degree of agitation of the automatic transmission fluid based on the detected engine speed and the detected automatic transmission fluid temperature;
adding the calculated degree of agitation to a previously calculated degree of agitation to obtain a sum degree; and
controlling the automatic transmission based on the sum degree.

13. The control method according to claim 12, wherein a higher degree of agitation is calculated as the rotational speed and the temperature increase, and a lower degree of agitation is calculated as either the rotational speed or the temperature decrease.

14. The control method according to claim 12, further comprising controlling the automatic transmission to prevent an increase in the rotational speed of the engine when the sum degree is higher than a preset degree.

15. The control method according to claim 14, farther comprising prohibiting the downshifting when the sum degree is higher than the preset degree, and a preset condition for at least one of an opening degree of an accelerator, a depression force of a brake pedal and a rotational speed of an output shaft in the automatic transmission is met.

16. The control method according to claim 14, further comprising canceling the prohibition of the downshifting when the sum degree is less than the preset degree, and a preset condition for at least one of an operating amount of an accelerator, a depression force of a brake pedal and a rotational speed of an output shaft in the automatic transmission is met.

17. The control method according to claim 12, wherein:
the automatic transmission has a rotation elevation mode in which the rotational speed of the engine at a given speed of the vehicle is higher than a normal rotational speed of the engine at the given speed of the vehicle, or a cruise mode in which gear shifting is controlled either for maintaining a predetermined vehicle speed or for maintaining a predetermined distance behind a preceding vehicle; and
the control method farther comprises prohibiting a conversion to the rotation elevation mode or the cruise mode.

18. The control method according to claim 12, wherein:
the automatic transmission has an automatic shift mode and a manual shift mode; and
the control method further comprises controlling the automatic transmission based on the sum degree to prevent at least a downshift in the manual shift mode.

19. A program of implementing the control method according to claim 12 by a computer.

20. A storage medium for storing a program for implementing the control method according to claim 12 by a computer.
